(19) United States
(12) Patent Application Publication
(10) Pub. No.: US 2007/0252690 A1
(43) Pub. Date: Nov. 1, 2007

(54) Child tracker apparatus

(76) Inventor: Matthew D. Pate, Kokomo, IN (US)

Correspondence Address: Frank D. Lachenmaier, 116 N. Main St., P.O. Box 1047, Kokomo, IN, 46903-1047, US

(21) Appl. No.: 11/607,155

(22) Filed: Dec. 1, 2006

Related U.S. Application Data
(60) Provisional application No. 60/795,978, filed on Apr. 28, 2006.

(51) Int. Cl. G08B 1/08; G08B 23/00

(52) U.S. Cl. 340/539.13; 340/573.4

(57) ABSTRACT

This invention relates generally to movable object tracking systems. More specifically, this invention relates to a child tracker apparatus that can be attached to a child and tracked on demand. A unique feature of this invention is that the tracker apparatus is built into an orthodontic appliance that provides a high stealth factor and makes it difficult to remove. When activated it transmits its location through a cellular network to a communication, monitoring and control center and finally to one of a family of display devices.

### BACKGROUND

1. Field of Invention

This invention relates generally to movable object tracker systems. More specifically, this invention relates to an apparatus that can be attached to a child and tracked on demand. A unique feature of this invention is that the apparatus is built into an orthodontic appliance that provides a high stealth factor and makes it difficult to remove. When activated it transmits its location through a cellular network to a communication, monitoring and control center and then to any one of a family of display or communication devices such as telephone, internet, laptop, hand held tracking modules, etc.

2. Prior Art

Currently GPS receivers are mounted in bracelets or other jewelry, installed in backpacks, attached to clothing or inserted in shoes to allow determination of the location of a child at any given point in time. Unfortunately, one of the first things an abductor is likely to do is to quickly change the child's appearance by replacing the clothes that the child was wearing at the time of the abduction and discarding or destroying an obvious tracking device.

### SUMMARY

The general object of the present invention is to provide a safe and easy to use tracking apparatus that is attached securely to a child without subcutaneous intervention in such a manner as to be undetectable by a potential abductor.

In the first embodiment a power source, a transceiver and antenna, and an RFID device are attached to a set of transpalatal wires that are mounted on orthodontic bands that are cemented to the maxillary molars.

A second embodiment has a power source, a transceiver and antenna, and an RFID device embedded in a typical molded plastic retainer. This embodiment can be removed while the child is eating and is also easier to clean, install and change the batteries when required.

A third embodiment adds a GPS receiver and antenna to the orthodontic appliance.

A fourth embodiment embeds a GPS receiver and antenna in a typical molded plastic retainer.

The specific objective of this invention is to provide a very low power consumption child tracker system that utilizes the existing infrastructure and takes advantage of government mandated location capabilities of cell phones or other cellular devices that are in the vicinity of the child tracker apparatus known as opportunity carriers:
1. to serve as an apparatus used in tracking a missing child when mounted in an orthodontic appliance utilizing signals from a plurality of cellular towers, calculating and communicating its location coordinates, utilizing a low power wireless communication technology connected to a cellular network, to a communication center on demand.

2. to serve as an apparatus used in tracking a missing child when mounted in an orthodontic appliance utilizing signals from a minimum of three Global Positioning Satellites and positioning capability of proximate cellular devices to calculate and communicate its location coordinates, utilizing a low power wireless communication technology connected to a cellular network, to a communication center on demand.

3. to serve as an apparatus used in tracking a missing child when mounted in an orthodontic appliance utilizing signals from a minimum of three Global Positioning Satellites and an onboard GPS receiver communicating its location coordinates, utilizing a low power wireless communication technology connected to a cellular network, to a communication center on demand.

4. to serve as an apparatus used in tracking a missing child when mounted in an orthodontic appliance utilizing signals from a combination of Global Positioning Satellites and cellular towers and positioning capability of proximate cellular devices to calculate and communicate its location coordinates, utilizing a low power wireless communication technology connected to a cellular network, to a communication center on demand.

### DRAWINGS

In order that the invention may be more fully understood it will now be described by way of example, with reference to the accompanying drawings in which:

FIG. 1 is a perspective view of a Child Tracker Apparatus showing a power source, a transceiver and antenna, and an RFID device attached to an orthodontic appliance mounted on a child's upper rear molars.

FIG. 2 is a perspective view of a Child Tracker Apparatus showing a power source, a transceiver and antenna, and an RFID device embedded in a typical retainer.

FIG. 3 is perspective view of a Child Tracker Apparatus showing a power source, a transceiver and antenna, an RFID device and a GPS receiver and antenna attached to an orthodontic appliance mounted on a child's upper rear molars.

FIG. 4 is perspective view of a Child Tracker Apparatus showing a power source, a transceiver and antenna, an RFID device and a GPS receiver and antenna embedded in a typical retainer.

FIG. 5 is a block diagram of a system utilizing a cellular tower triangulation method for position calculation and a cellular communication link between a control center and Child Tracker Apparatus.

FIG. 6 is block diagram of a system utilizing a global positioning satellite system and the positioning capability in proximate cellular devices and a cellular communication link between a control center and a Child Tracking Apparatus.

FIG. 7 is a block diagram of a system utilizing a global positioning satellite system, an onboard GPS receiver and antenna for position calculation and a cellular communication link between a control center and a Child Tracking Apparatus.

### REFERENCE NUMERALS

The same reference numbers are used to refer to the same or similar parts in the various views.

10 - Child Tracker Tracker
12 - transceiver & antenna
14 - GPS antenna
16 - removable power source
18 - pressure activated on-switch
20 - retainer
22 - transpalatal arch wires
24 - orthodontic bands
26 - global positioning satellites (not
part of this invention)
28 - coordinate display (not part of
this invention)
30 - maxillary molars (not part of this
invention)
32 - upper arch (not part of this
invention)
34 - communication, monitoring and
control center (not part of this
invention)
36 - GPS receiver
38 - cell phone tower (not part of this
invention)
40 - opportunity carrier (proximate
cellular device (not part of this
invention))
42 - RFID device
44 - alarm (not part of this invention)

### DESCRIPTION

In order that the invention may be more fully understood, Child Tracker Apparatus 10 will now be described by way of example with reference to the accompanying drawings.

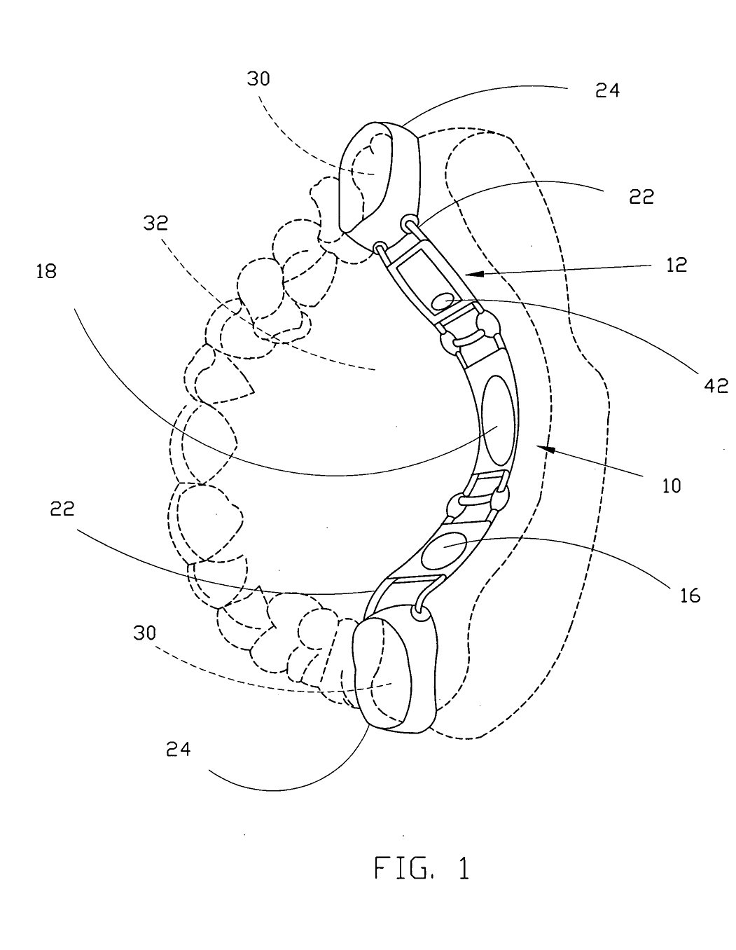

FIG. 1 illustrates an embodiment of Child Tracker Apparatus 10 that is comprised of orthodontic bands 24 cemented to maxillary molars 30 in a child's mouth. There are two transpalatal arch wires 22 silver soldered to orthodontic bands 24 arching above them into upper arch 32 of roof of the child's mouth. Fastened to transpalatal arch wires 22 are transceiver and antenna 12, removably attached power source 16, RFID device 42 and pressure activated on-switch 18 to allow the child to transmit his location if he is lost or abducted.

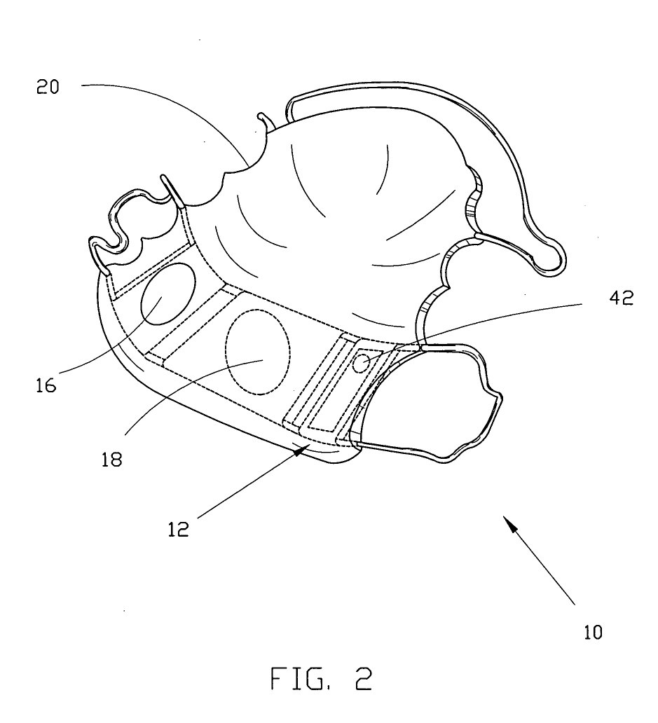

FIG. 2 shows a second embodiment of Child Tracker Apparatus 10 mounted in a typical Hawley retainer 20 with transceiver and antenna 12, pressure activated on-switch 18, RFID device 42 and removable power source 16 embedded in the plastic body.

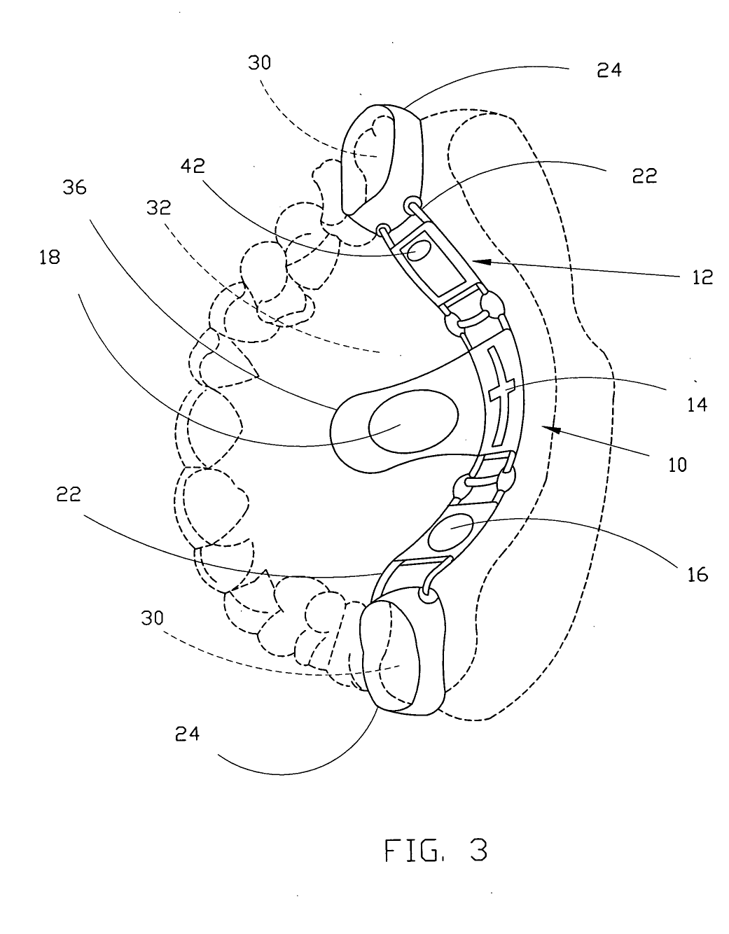

FIG. 3 illustrates a third embodiment of Child Tracker Apparatus 10 that is comprised of orthodontic bands 24 cemented to maxillary molars 30 in a child's mouth. There are two transpalatal arch wires 22 silver soldered to orthodontic bands 24 arching above them into upper arch 32 of roof of the child's mouth. Fastened to transpalatal arch wires 22 are transceiver and antenna 12, removable power source 16, RFID device 42, and pressure activated on-switch 18, GPS receiver 36 and antenna 14.

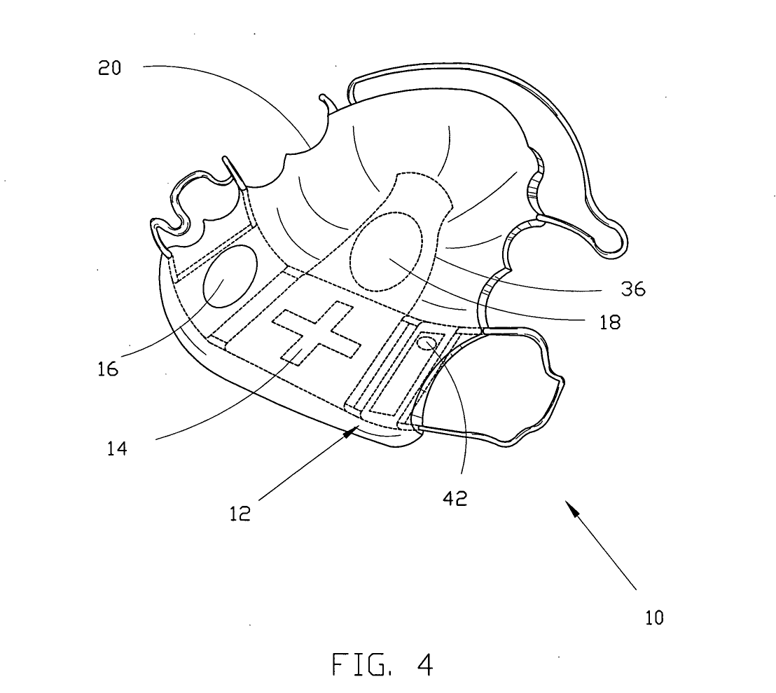

FIG. 4 shows a fourth embodiment of Child Tracker Apparatus 10 mounted in a typical Hawley retainer 20 with transceiver and antenna 12, pressure activated on-switch 18, RFID device 42, removable power source 16, GPS receiver 36 and antenna 14 embedded in the plastic body.

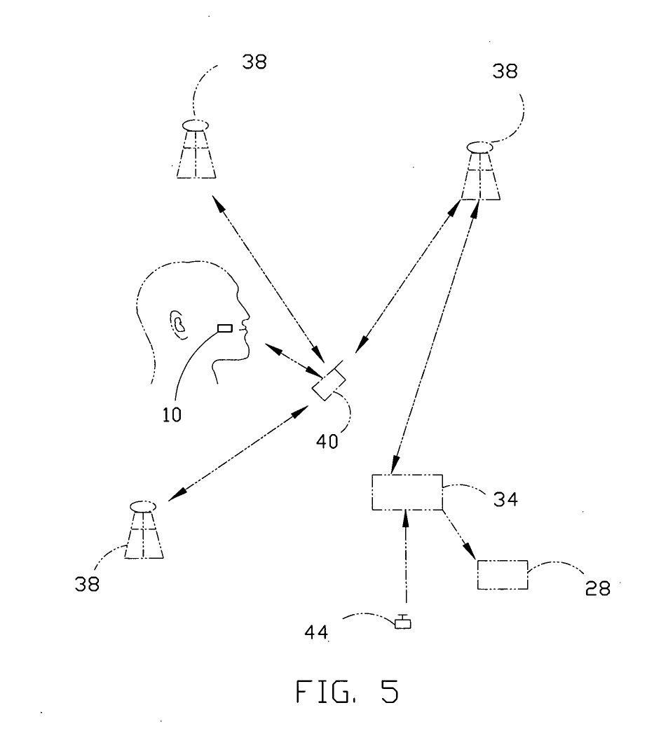

FIG. 5 shows Child Tracker Apparatus 10 installed in a child's mouth utilizing the commonly known triangulation technique with a plurality of cellular towers 38, to determine the location coordinates of opportunity carrier 40 in a proximate position to Child Tracker Apparatus 10. Communication, monitoring and control center 34 is shown sending the wake up and report alarm 44 to Child Tracker Apparatus 10 and receiving its location coordinates in return. Communication, monitoring and control center 34 is then shown feeding location coordinates to coordinate display 28.

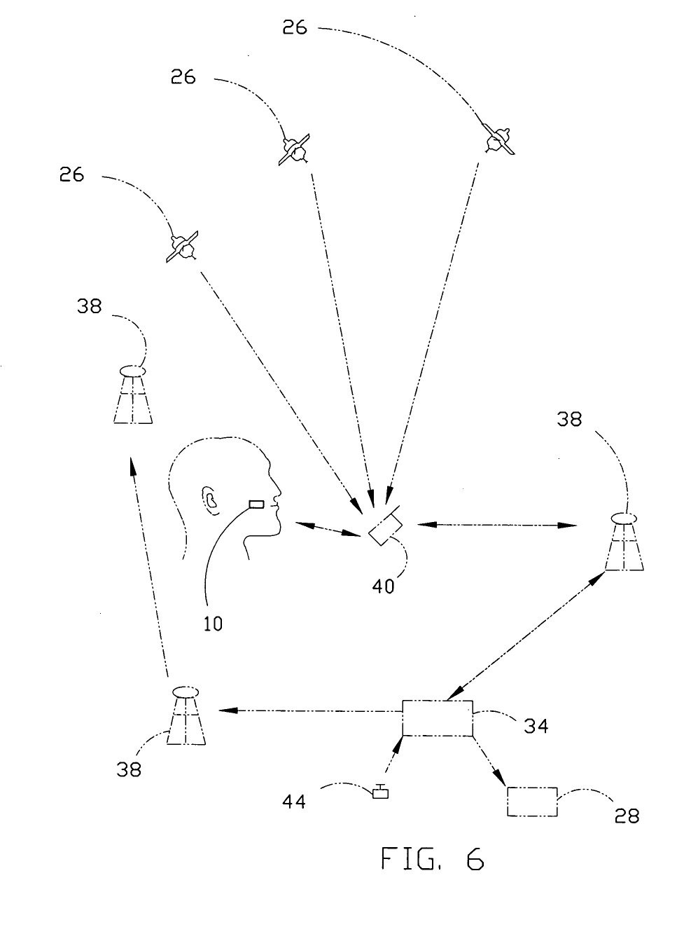

FIG. 6 shows Child Tracker Apparatus 10 installed in a child's mouth utilizing a global positioning satellite system with a minimum of three satellites 26 and the positioning capability in cellular devices in close proximity to Child Tracker Apparatus 10 known as opportunity carriers 40 to determine the location coordinates of opportunity carrier 40. Communication, monitoring and control center 34 is shown sending the wake up and report alarm 44 to Child Tracker Apparatus 10 and receiving its location coordinates in return. Communication, monitoring and control center 34 is then shown feeding location coordinates to coordinate display 28.

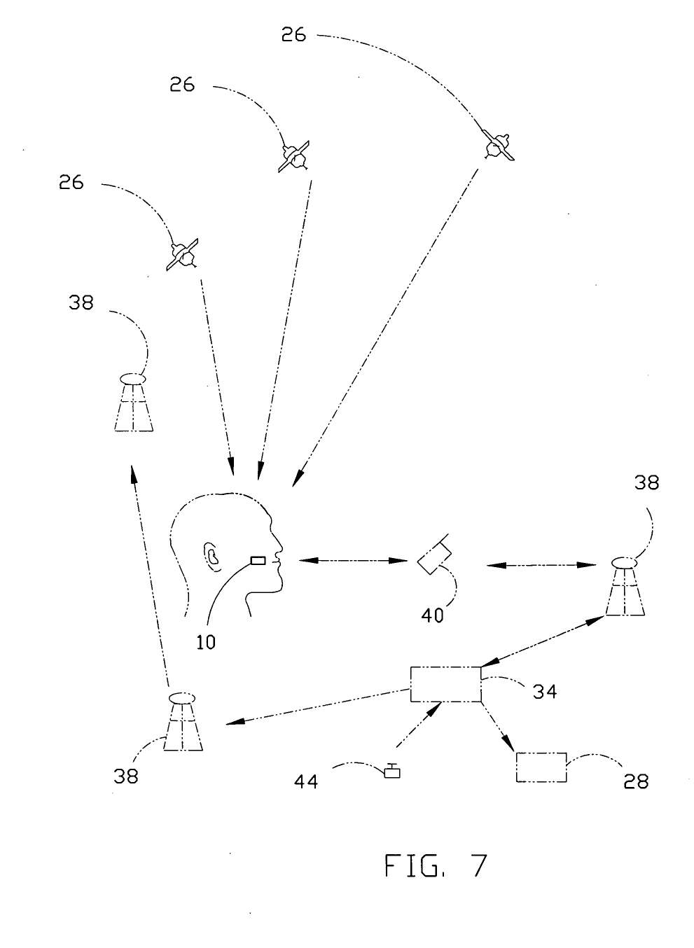

FIG. 7 shows Child Tracker Apparatus 10 installed in a child's mouth utilizing a global positioning satellite system with a minimum of three satellites 26 and GPS receiver 36 to determine the location coordinates of Child Tracker Apparatus 10. Communication, monitoring and control center 34 is shown sending wake up and report alarm 44 to Child Tracker Apparatus 10 and receiving its location coordinates in return. Communication, monitoring and control center 34 is then shown feeding location coordinates to coordinate display 28.

The preferred embodiments show a replaceable, rechargeable battery as power source 16. This invention also encompasses such systems as those that convert the kinetic energy from the motion of the jaw during eating, speech and general movement into electrical energy to be fed back into the battery to extend its life. Other low power battery systems can be made from the normal acidity of human saliva which can also be used to create small charging current to prolong the battery life.

### OPERATION

FIG. 5 shows a system for the operation of the first and second embodiments of Child Tracker apparatus 10. Child Tracker Apparatus 10 is given a wake up and report command when opportunity carrier 40 recognizes RFID device 42 after communication, monitoring and control center 34 has broadcast alarm 44, or is turned on by a child in distress by applying pressure to on-switch 18. When Child Tracker Apparatus 10 is activated it sends out its RFID device 42 identity data and the time through the onboard transceiver 12, utilizing an existing low cost and power, wireless communication technology such as Zigbee™ or Bluetooth™ to opportunity carrier 40 which is any position location capable cellular device in the proximity of Child Tracker Apparatus 10. A commonly known triangulation method using multiple cellular towers is utilized for locating the position of opportunity carrier 40. Opportunity carrier 40 relays its location coordinates through a cellular network of ubiquitous towers 38 to readily available Wide Area Network systems to communication, monitoring and control center 34 and then to one of a family of coordinate display units 28.

FIG. 6 shows a second system for the operation of the first and second embodiments of Child Tracker Apparatus 10. Child Tracker Apparatus 10 is given a wake up and report command when opportunity carrier 40 recognizes RFID device 42 after communication, monitoring and control center 34 has broadcast alarm 44, or is turned on by a child in distress by applying pressure to on-switch 18. When Child Tracker Apparatus 10 is activated it sends out its RFID device 42 identity data and the time through the onboard transceiver 12 utilizing an existing low cost and power wireless communication technology such as Zigbee™ or Bluetooth™ to opportunity carrier 40. It then utilizes the positioning capability in opportunity carriers 40 and a minimum of three satellites 26 or a combination of less than three satellites 26 and one or more cellular towers 38 for determining its location coordinates. Opportunity carrier 40 relays the location coordinates through a cellular network of ubiquitous towers 38 to readily available Wide Area Network systems to communication, monitoring and control center 34 and then to one of a family of coordinate display units 28.

FIG. 7 shows a third system for the operation of the third and fourth embodiments of Child Tracker Apparatus 10. Child Tracker Apparatus 10 is given a wake up and report command when opportunity carrier 40 recognizes RFID device 42 after communication, monitoring and control center 34 has broadcast alarm 44, or is turned on by a child in distress by applying pressure to on-switch 18. When Child Tracker Apparatus 10 is activated, it utilizes GPS receiver 36 and a minimum of three satellites 26 to calculate its location coordinates. This system can also use a combination of two satellites 26 and one cellular tower 38 to calculate its location coordinates. It then sends out its RFID device 42 identity data, the time and its location coordinates through the onboard transceiver 12 utilizing an existing low cost and power wireless communication technology such as Zigbee™ or Bluetooth™ to opportunity carrier 40. Opportunity carrier 40 relays the location coordinates through a cellular network of ubiquitous towers 38 to readily available Wide Area Network systems to communication, monitoring and control center 34 and then to one of a family of coordinate display units 28.

Each unit of Child Tracker Apparatus 10 is programmable at the installation point with individual identification numbers as with RFID devices 42 that contain the preferred identification communication chain of events and structures. Child Tracker Apparatus 10 can be programmed to function with any commercially available communication, monitoring and control center 34. Speed and direction of movement can also be ascertained by using timed queries.

Satellites 26, opportunity carriers 40, cellular towers 38 communication, data collection and monitoring centers 34, coordinate display 28, molars 30, and the upper arch 32 and alarm 44 are shown in phantom lines for illustrative purposes and form no part of this invention.

The preceding descriptions are for illustrative purposes and are not intended to limit the scope of this invention. The scope of the invention should be determined by the appended claims rather than by the specific examples given.

What is claimed is:

1. A child tracking apparatus positioned inside a child's mouth, comprising:
an orthodontic appliance constructed from orthodontic bands cemented to the maxillary molars of said child;
a pair of transpalatal arch wires silver soldered to said orthodontic bands, that arch into the upper arch of said child's mouth;
an RFID device programmed with unique identity data, mounted to said arch wires;
a transceiver and antenna mounted to said arch wires whereby radio frequency wake up and report signals are received from nearby opportunity carriers (cellular devices) through an ubiquitous cellular telephone network, after a guardian who has realized said child is missing, communicates an alarm to a communication, monitoring and control center requesting said RFID device equipped child tracker apparatus location coordinates and that message is broadcast over said network;
an on-switch mounted to said arch wires whereby wake up and report commands are alternatively sent when pressure is applied to said on-switch by said child when lost or abducted; whereby
said transceiver and antenna using a wireless technology transmit said RFID data and the time to said opportunity carriers that are in proximity of said child tracking apparatus, and the location coordinates of the proximate opportunity carrier are determined using the commonly known triangulation method with multiple cellular towers, and relayed though said cellular communication network to said communication, monitoring and control center and to a coordinate display;
and a power source mounted to said arch wires.

2. A child tracking apparatus positioned removably inside a child's mouth, comprising:
an orthodontic appliance constructed as a typical molded plastic retainer type apparatus;
an RFID device programmed with unique identity data, embedded in said retainer;
a transceiver and antenna imbedded in said retainer whereby radio frequency wake up and report signals are received from nearby opportunity carriers (cellular devices) through an ubiquitous cellular telephone network after a guardian who has realized said child is missing, communicates an alarm to said communication, monitoring and control center (not part of this invention), requesting said RFID device equipped child tracker system location data and that alarm is broadcast over said network;
an on-switch imbedded in said retainer whereby wake up and report commands are sent when pressure is applied by said child when lost or abducted; and whereby
said transceiver and antenna, using a wireless technology, transmit said RFID data and the time to said opportunity carriers that are in proximity of said child tracking apparatus, and the location coordinates of the proximate opportunity carrier are determined using the triangulation method with multiple cellular towers relayed though said cellular communication network to said communication, monitoring and control center and to said coordinate display;
and a power source mounted to said arch wires.

3. A child tracking apparatus positioned inside a child's mouth, as in claim 1 whereby:
said transceiver and antenna, using a wireless technology, transmit said RFID device identity data and the time to said opportunity carriers that are in proximity of said child tracking apparatus, and the location coordinates of said opportunity carrier are determined using the Federally mandated positioning capability of location capable cellular phones and relayed though said cellular communication network to said communication, monitoring and control center and to said coordinate display.

4. A child tracking apparatus positioned inside a child's mouth, as in claim 2 whereby:
said transceiver and antenna, using a wireless technology, transmit said RFID device identity data and the time to said opportunity carriers that are in proximity of said child tracking apparatus, and the location coordinates of said opportunity carrier are determined using the Federally mandated positioning capability of location capable cellular phones and relayed though said cellular communication network to said communication, monitoring and control center and to said coordinate display.

5. A child tracking apparatus positioned inside a child's mouth, as in claim 1 further comprising:
a GPS antenna mounted to said arch wires whereby coordinated timed signal pulses that are sent from multiple satellites (not part of this invention) are received; and transmitted to
a GPS receiver mounted to said arch wires whereby said GPS receiver calculates its location coordinates using commonly known techniques; and communicates said location data and said RFID device identity data back through said transceiver, using a wireless technology to said opportunity carriers that are in proximity of said child tracking apparatus, that relay it though said cellular communication network to said communication, monitoring and control center and to said coordinate display.

6. A child tracking apparatus positioned inside a child's mouth, as in claim 2 further comprising:
a GPS antenna embedded in said retainer whereby coordinated timed signal pulses that are sent from multiple satellites (not part of this invention) are received; and transmitted to
a GPS receiver embedded in said retainer whereby said GPS receiver calculates its location coordinates using commonly known techniques; and communicates said location data and said RFID device identity data back through said transceiver, using a wireless technology to said opportunity carriers, that are in proximity of said child tracking apparatus, relay ithough said cellular communication network to said communication, monitoring and control center and to said coordinate display.
